(19) United States
(12) Patent Application Publication
(10) Pub. No.: US 2012/0153206 A1
(43) Pub. Date: Jun. 21, 2012

(54) Ball Valve

(75) Inventor: Chih-Chien Yin, Chiayi County (TW)

(73) Assignee: Zipson Steel Industrial Co., Ltd.

(21) Appl. No.: 12/970,454

(22) Filed: Dec. 16, 2010

(51) Int. Cl. F16K 5/06

(52) U.S. Cl. 251/315.1

(57) ABSTRACT

A ball valve includes a valve housing, which includes a housing body having opposite first and second sides, and an inner surface formed with a ball socket. The valve housing also includes a first cap mounted to the first side of the housing body, and a valve ball disposed in the ball socket and formed with an outer surface and a ball channel. The valve ball is drivable to move between an open position and a closed position to respectively permit or block fluid flow between the first cap opening and the ball channel. The ball valve also includes a first sealing mechanism mounted in the ball socket and formed with a first passage. The first sealing mechanism includes components made of metal, and cooperates with the housing body and the valve ball to form a fluid-tight seal around the first passage between the valve ball and the first cap.

### BACKGROUND OF THE INVENTION

1. Field of the Invention

The present invention relates to a ball valve, and more particularly to a ball valve adapted for delivery of high-temperature and high-pressure fluid.

2. Description of the Related Art

A conventional ball valve 1, illustrated in FIG. 1, may be used in medical or biochemical applications to regulate fluid flow in ducts. The conventional ball valve 1 may include a frame 11, a pair of side caps 12, a valve ball 13 disposed in the frame 11, and a pair of conventional sealing mechanisms 14. The conventional sealing mechanisms 14 may include plastic components that become damaged or worn due to high fluid temperatures and pressures. As a result, the conventional ball valve 1 may allow leakage to occur.

### SUMMARY OF THE INVENTION

An object of the present invention is to provide a ball valve that can be used in a high-temperature and high-pressure fluid environment for delivery of fluids while preventing leakage.

According to this invention, a ball valve includes a valve housing, which includes a housing body having opposite first and second sides, and an inner surface formed with a ball socket having an opening at each of the first and second sides. The ball valve further includes a first cap mounted to the first side of the housing body. The first cap is formed with a first cap opening in fluid communication with the ball socket. The valve housing further includes a valve ball disposed in the ball socket and formed with an outer surface and a ball channel. The valve ball is drivable to move between an open position to permit fluid flow between the first cap opening and the ball channel, and a closed position to block fluid flow between the first cap opening and the ball channel using the outer surface of the valve ball.

The ball valve also includes a first sealing mechanism mounted in the ball socket and formed with a first passage for permitting fluid communication between the first cap opening and the ball channel of the valve ball. The first sealing mechanism cooperates with the housing body and the valve ball to form a fluid-tight seal around the first passage between the valve ball and the first cap. The first sealing mechanism includes a first seat ring, a first inner ring, a first outer ring, and a first biasing member. The first seat ring is made of metal and abuts against the outer surface of the valve ball. The first inner ring is made of metal, abuts against the first seat ring opposite the valve ball, and abuts against the inner surface of the housing body. The first outer ring is made of metal, abuts against the first inner ring, and is sheathed over the first seat ring. The first biasing member is made of metal, and biases the first outer ring away from the first cap. An opening formed in each of the first seat ring, the first inner ring, and the first outer ring cooperate to form the first passage of the first sealing mechanism.

The first sealing mechanism forms a fluid-tight seal between the first cap and the valve ball around the first passage. Due to the metal components of the first sealing mechanism, the ball valve is capable of fluid delivery without deformation of the ball valve components or leakage due to high temperatures or pressures of the fluid that is being delivered. In addition, the first sealing mechanism prevents the valve ball from being displaced too far towards the first cap, which may cause friction between the valve ball and the first seat ring that hinders rotation of the valve ball during opening or closing operations of the ball valve. The ball valve therefore may be used with an automatic operating mechanism with lower driving capability.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary sectional view of a conventional ball valve;

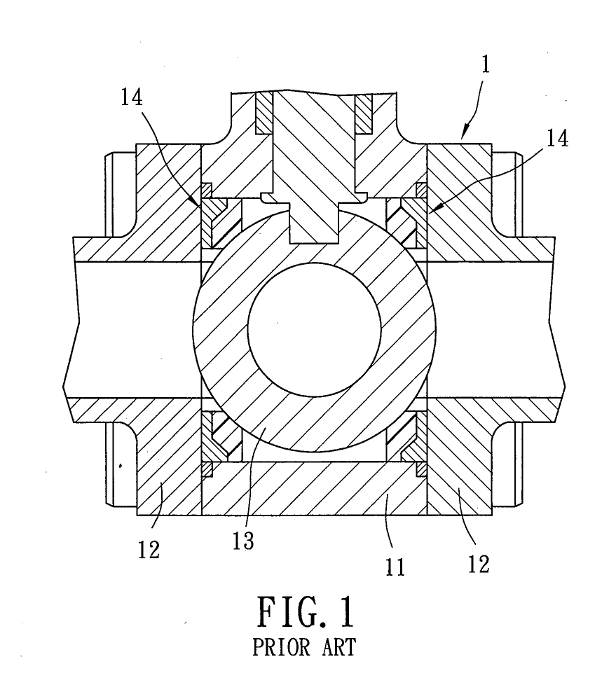

FIG. 2 is an exploded perspective view illustrating the preferred embodiment of a ball valve according to the present invention;

FIG. 3 is a partly sectional view illustrating the preferred embodiment at an open position;

FIG. 4 is a fragmentary enlarged partly sectional view of FIG. 3; and

FIG. 5 is a fragmentary enlarged partly sectional view illustrating the preferred embodiment at a closed position.

### DETAILED DESCRIPTION OF THE PREFERRED EMBODIMENT

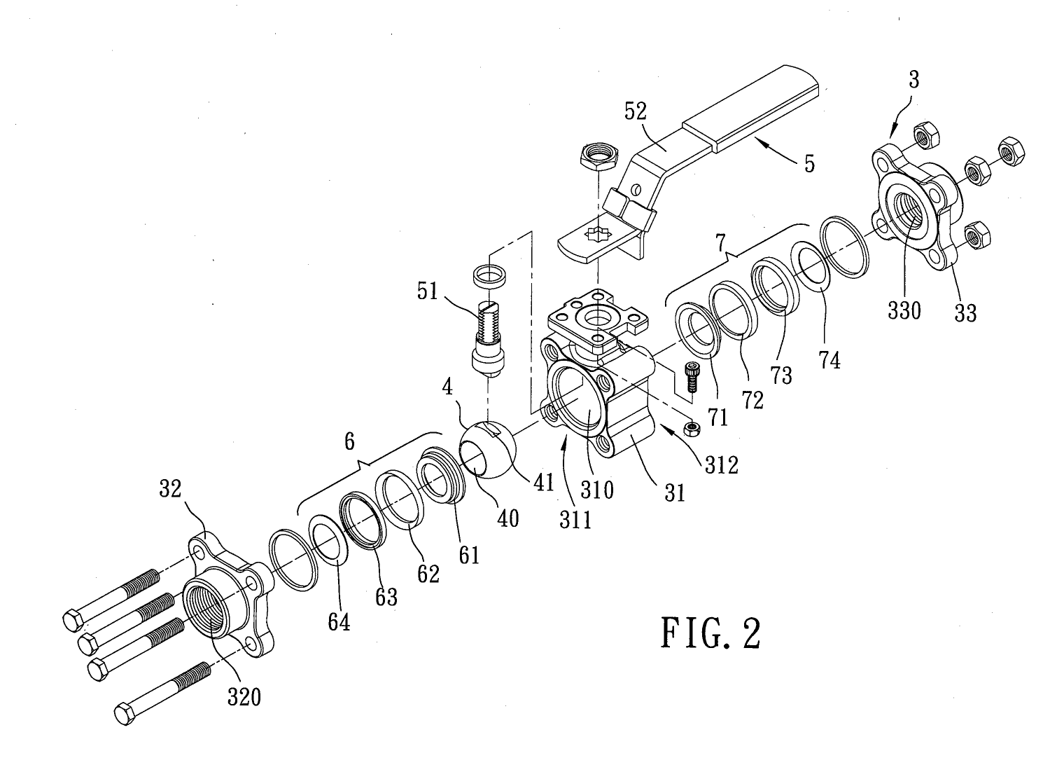

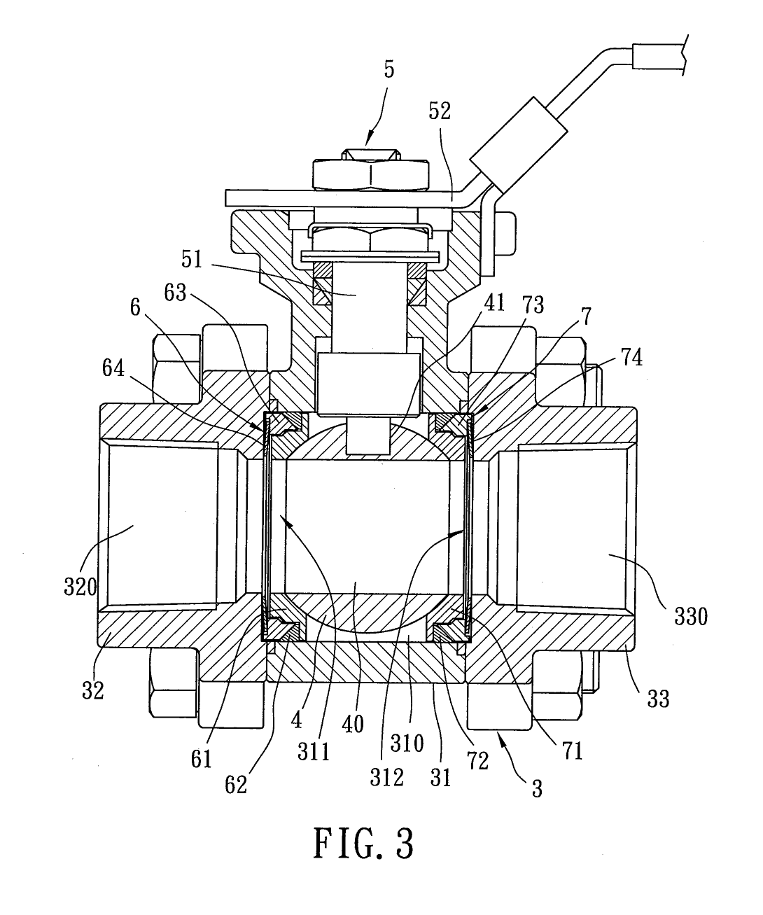

Referring to FIGS. 2 to 4, the preferred embodiment of a ball valve according to the present invention can be mounted between two conducting ducts (not shown) and used for delivery of high pressure and high temperature fluid. The ball valve includes a valve housing 3, a valve ball 4 disposed in the valve housing 3, a valve control mechanism 5 mounted pivotably to a top side of the valve housing 3 and connected to the valve ball 4, and first and second sealing mechanisms 6, 7 disposed at opposite respective sides of the valve housing 3.

The valve housing 3 includes a housing body 31 formed with a first side 311 and a second side 312 disposed opposite to the first side 311. The housing body 31 has an inner surface formed with a ball socket 310 that opens at each of the first and second sides 311, 312. The valve housing 3 further includes a pair of first and second caps 32, 33 each mounted to a respective one of the first and second sides 311, 312 of the housing body 31. The first and second caps 32, 33 are formed respectively with a first and a second cap opening 320, 330 that are in fluid communication through the ball socket 310.

The valve ball 4 is disposed in the ball socket 310 and retained by the first and second caps 32, 33. The valve ball 4 is formed with an outer surface, a control slot 41 formed in the outer surface, and a ball channel 40.

The valve control mechanism 5 is mounted to a top side of the housing body 31, and can be operated to drive the valve ball 4 to rotate in the housing body 31. The valve control mechanism 5 includes a shaft 51 extending through the housing body 31 and engaged with the control slot 41 of the valve ball 4, and a lever 52 coupled to a top end of the shaft 51. Because the valve control mechanism 5 is not the focus of this invention, further details are not provided herein for the sake of brevity.

The first and second sealing mechanisms 6, 7 are mirror images of each other, and are each abutted against a respective side of the outer surface of the valve ball 4 to form a fluid-tight seal. Each of the first and second sealing mechanisms 6, 7 is disposed between the housing body 31 and a respective one of the first and second caps 32, 33 to prevent fluid leakage between the valve ball 4 and the ball socket 310. Each of the first and second sealing mechanisms 6, 7 is mounted in the ball socket 310 and formed with a respective one of a first and a second passage for permitting fluid communication between the first and second cap openings 320, 330 through the ball channel 40 of the valve ball 4. Each of the first and second sealing mechanisms 6, 7 cooperates with the housing body 31 and the valve ball 4 to form a fluid-tight seal between the valve ball 4 and the respective one of the first and second caps 32, 33 around the respective one of the first and second passages.

The valve ball 4 is drivable to move between an open position and a closed position. At the open position, the valve ball 4 permits fluid flow between the first and second cap openings 320, 330 through the ball channel 40. At the closed position, the outer surface of the valve ball 4 blocks fluid flow between the first and second cap openings 320, 330 through the ball channel 40. For convenience, the structure of the first sealing mechanism 6 is first described below.

The first sealing mechanism 6 includes a first seat ring 61 that is made of metal and that abuts against the outer surface of the valve ball 4 to form a fluid-tight seal. The first sealing mechanism 6 also includes a first inner ring 62 that is made of metal, that abuts against the first seat ring 61 opposite the valve ball 4, and that abuts against the inner surface of the housing body 31. The first sealing mechanism 6 further includes a first outer ring 63 that is made of metal, that abuts against the first inner ring 62, and that is sheathed over the first seat ring 61. The first sealing mechanism 6 further includes a ring-shaped first biasing member 64 that is made of metal and that biases the first outer ring 63 away from the first cap 32. An opening formed in each of the first seat ring 61, the first inner ring 62, the first outer ring 63, and the first biasing member 64 cooperate to form the first passage of the first sealing mechanism 6.

Each of the first seat ring 61, the first inner ring 62, the first outer ring 63 and the first biasing member 64 is made of metal that can withstand high temperatures without being deformed. The metal used for manufacturing each part is not limited to the same material.

The first seat ring 61 includes a first seat body 611 that abuts against the outer surface of the valve ball 4 and that has an outer ring wall. The first seat ring 61 also includes a first radial flange 612 that extends away from the outer ring wall of the first seat ring 61. The first inner ring 62 is retained between the first radial flange 612 and the first outer ring 63 to be driven against the inner surface of the housing body 31. The first inner ring 62 tapers toward the first outer ring 63, and has a first inclined face 621 that abuts against the first outer ring 63.

The first outer ring 63 includes a first ring body 631 for sleeving over the outer ring wall of the first seat body 611, and a first spacer 633 extending from the first ring body 631 toward the first cap 32. The first outer ring 63 further includes a first wedge 634 that projects from the first ring body 631 and that is formed with a first wedge face 635 for abutting against the first inclined face 621 to drive the first inner ring 62 toward the inner surface of the housing body 31. The first biasing member 64 is radially positioned by the first spacer 633, and abuts against the first cap 32 and the first outer ring 63 opposite the first radial flange 612.

The structure of the second sealing mechanism 7 is the same as the structure of the first sealing mechanism 6. The second sealing mechanism 7 includes a second seat ring 71, a second inner ring 72, a second outer ring 73 and a second biasing member 74 that are each made of metal. An opening formed in each of the second seat ring 71, the second inner ring 72, the second outer ring 73, and the second biasing member 74 cooperate to form the second passage of the second sealing mechanism 7.

The second seat ring 71 includes a second seat body 711 and a second radial flange 712. The second seat body 711 abuts against the outer surface of the valve ball 4 and has an outer ring wall. The second radial flange 712 extends away from the outer ring wall of the second seat ring 71. The second inner ring 72 is retained between the second radial flange 712 and the second outer ring 73 to be driven against the inner surface of the housing body 31.

The second inner ring 72 tapers toward the second outer ring 73 and has a second inclined face 721 that abuts against the second outer ring 73. The second outer ring 73 has a second ring body 731, a second spacer 733, and a second wedge 734. The second ring body 731 sleeves over the outer ring wall of the second seat body 711, and the second spacer 733 extends from the second ring body 731 toward the second cap 33. The second wedge 734 projects from the second ring body 731, and is formed with a second wedge face 735 for abutting against the second inclined face 721 to drive the second inner ring 72 toward the inner surface of the housing body 31. The second biasing member 74 is positioned by the second spacer 733 and abuts against the second cap 33 and the second outer ring 73 opposite the second radial flange 712.

When the ball valve of this invention is in use, each of the first and second biasing members 64, 74 abuts against the respective one of the first and second outer rings 63, 73, and biases the respective ones of the first and second outer rings 63, 73, the first and second inner rings 62, 72 and the first and second seat rings 61, 71 toward the outer surface of the valve ball 4 to form a fluid-tight seal around the respective one of the first and second passages. Each of the first and second wedge faces 635, 735 of the respective first and second outer rings 63, 73 is pressed against the respective one of the first and second inclined faces 621, 721 of the respective one of the first and second inner rings 62, 72, which drives the respective one of the first and second inner rings 62, 72 radially outward against the inner surface of the housing body 31. In this way, each of the first and second sealing mechanisms 6, 7 cooperate with the housing body 31 and the valve ball 4 to form a fluid-tight seal around the respective one of the first and second passages between the valve ball 4 and the respective one of the first and second caps 32, 33.

When the valve ball 4 is rotated to the open position, the ball channel 40 is in fluid communication with the first and second cap openings 320, 330, and fluid may flow from the second cap opening 330 at the right to the first cap opening 320 at the left, i.e., the first passage and the first cap opening 320 cooperate to form a fluid outlet whereas the second passage and the second cap opening 330 cooperate to form a fluid inlet. When the valve ball 4 is rotated to the closed position, the outer surface of the valve ball 4 abuts against each of the first and second seat rings 61, 71 to form a fluid-tight seal and to block fluid flow between the first and second cap openings 320, 330 through the ball channel 40.

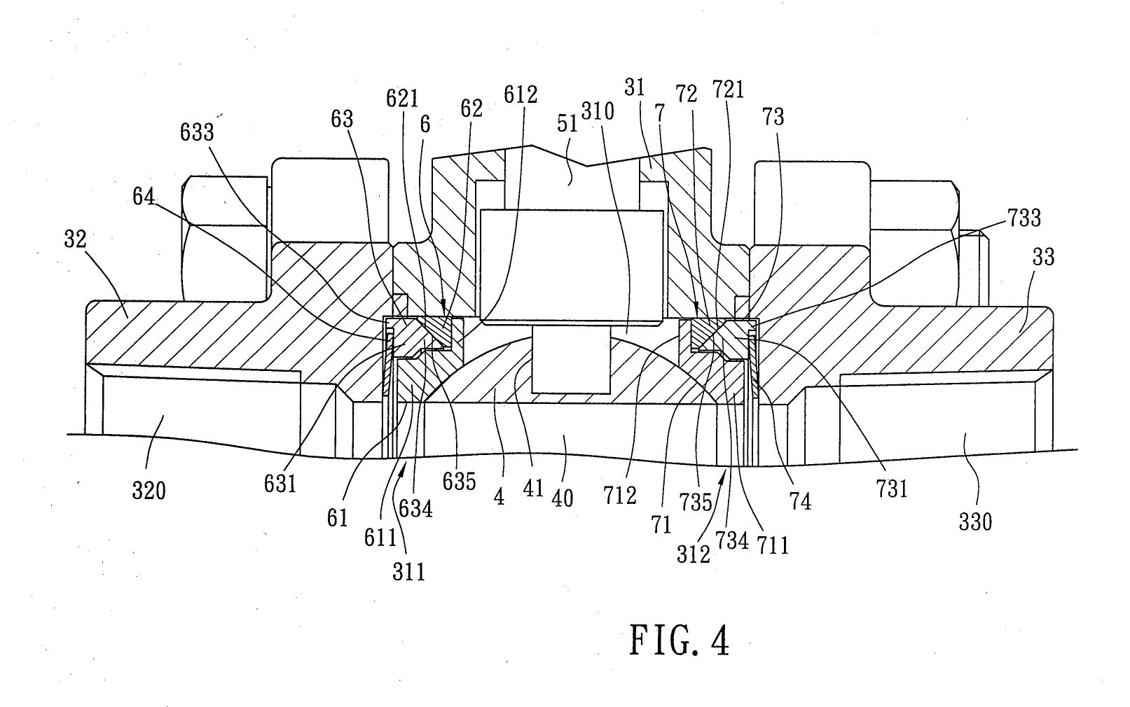

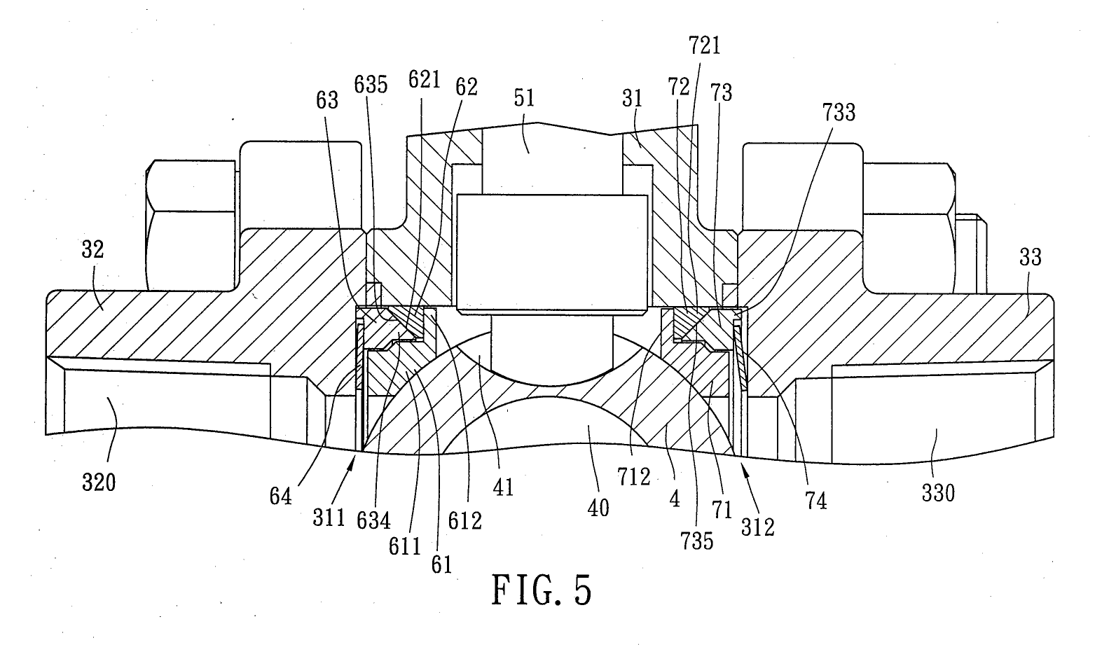

With reference to FIGS. 4 and 5, when the valve ball 4 is disposed at the closed position or a partially closed position, where the outer surface of the valve ball 4 only partially blocks the first and second cap openings 320, 330, the high-temperature or high-pressure fluid that impinges the outer surface of the valve ball 4 exposed to the second cap opening 330 moves the valve ball 4 toward the first seat ring 61. At this time, the first inner ring 62 and the first outer ring 63 are compressed between the first seat ring 61 and the first biasing member 64, and the first seat ring 61 is abutted with a fluid-tight seal against the outer surface of the valve ball 4. At the same time, the first inner ring 62 is pushed by the first radial flange 612 of the first seat ring 61 toward the first outer ring 63, and pushed by the first wedge face 635 of the first outer ring 63 radially and outwardly to abut the first inner ring 62 against the inner surface of the housing body 31. Accordingly, in addition to creating a fluid-tight seal in cooperation with the inner surface of the housing body 31 around the first passage of the first sealing mechanism 6, the first biasing member 64 resiliently buffers the movement of the valve ball 4 while limiting displacement of the valve ball 4 toward the first cap 32.

At the same time, the second biasing member 74 resiliently biases the second outer ring 73, the second inner ring 72, and the second seat ring 71 to abut the second seat ring 71 against the outer surface of the valve ball 4 to form a fluid-tight seal. The second inner ring 72 is pushed by the second radial flange 712 of the second seat ring 71 toward the second outer ring 73, and pushed by the second wedge face 735 of the second outer ring 73 radially and outwardly to abut the second inner ring 72 against the inner surface of housing body 31. Accordingly, the components of the second sealing mechanism 7 cooperate with the inner surface of the housing body 31 to form a fluid-tight seal around the second passage.

In addition, the first sealing mechanism 6 prevents the valve ball 4 from being displaced too close to the first cap 32, which may cause friction between the valve ball 4 and the first seat ring 61 that hinders rotation of the valve ball 4 during opening or closing operations of the ball valve. Use of the ball valve of the present invention therefore permits selection of an automatic operating mechanism with reduced driving capability for the ball valve.

Moreover, it should be noted that the main pressure bearing structure of the ball valve is the first or second sealing mechanism 6, 7 disposed at the exit side of the ball valve with respect to fluid flow. In the above example, the main pressure bearing structure is the first sealing mechanism 6. Accordingly, the designs of the first and second sealing mechanisms 6, 7 need not necessarily be the same. Provided that the structural components of the sealing mechanisms 6, 7 use metal materials that can endure high temperatures, and that the structural components are able to abut intimately against the outer surface of the valve ball 4 and the inner surface of the housing body 31, a fluid-tight seal may be achieved.

In summary, the first and second sealing mechanisms 6, 7 each forms a fluid-tight seal between the respective one of the first and second caps 32, 33 and the valve ball 4 around the respective one of the first and second passages. Due to the metal components of the sealing mechanisms 6, 7, the ball valve is capable of fluid delivery without deformation of the ball valve components or leakage due to high temperatures or pressures of the fluid that is being delivered. In addition, the first sealing mechanism 6 prevents the valve ball 4 from being displaced too close to the first cap 32, which may cause friction between the valve ball 4 and the first seat ring 61 that hinders rotation of the valve ball 4 during opening or closing operations of the ball valve. The ball valve therefore may be used with an automatic operating mechanism with lower driving capability.

While the present invention has been described in connection with what is considered the most practical and preferred embodiment, it is understood that this invention is not limited to the disclosed embodiment but is intended to cover various arrangements included within the spirit and scope of the broadest interpretation to encompass all such modifications and equivalent arrangements.

What is claimed is:

1. A ball valve comprising:
a valve housing including
a housing body having opposite first and second sides, and an inner surface formed with a ball socket having an opening at each of said first and second sides, and
a first cap mounted to said first side of said housing body and formed with a first cap opening in fluid communication with said ball socket;
a valve ball disposed in said ball socket and formed with an outer surface and a ball channel, said valve ball being drivable to move between an open position to permit fluid flow between said first cap opening and said ball channel, and a closed position to block fluid flow between said first cap opening and said ball channel using said outer surface of said valve ball; and
a first sealing mechanism mounted in said ball socket and formed with a first passage for permitting fluid communication between said first cap opening and said ball channel of said valve ball, said first sealing mechanism cooperating with said housing body and said valve ball to form a fluid-tight seal around said first passage between said valve ball and said first cap, said first sealing mechanism including
a first seat ring made of metal and abutting against said outer surface of said valve ball,
a first inner ring made of metal, abutting against said first seat ring opposite said valve ball, and abutting against said inner surface of said housing body,
a first outer ring made of metal, abutting against said first inner ring, and being sheathed over said first seat ring, and
a first biasing member made of metal and biasing said first outer ring away from said first cap,
wherein an opening formed in each of said first seat ring, said first inner ring, and said first outer ring cooperate to form said first passage of said first sealing mechanism.

2. The ball valve as claimed in claim 1, wherein
said first seat ring includes a first seat body abutting against said outer surface of said valve ball and having an outer ring wall, and a first radial flange extending away from said outer ring wall, and
said first inner ring is retained between said first radial flange and said first outer ring to be driven against said inner surface of said housing body.

3. The ball valve as claimed in claim 2, wherein:
said first inner ring tapers toward said first outer ring, and has a first inclined face that abuts against said first outer ring;
said first outer ring includes
a first ring body for sleeving over said outer ring wall of said first seat body,
a first spacer extending from said first ring body toward said first cap, and
a first wedge projecting from said first ring body and formed with a first wedge face for abutting against said first inclined face to drive said first inner ring towards said inner surface of said housing body; and
said first biasing member is positioned by said first spacer, and abuts against said first cap and said first outer ring opposite said first radial flange.

4. The ball valve as claimed in claim 3, wherein said first biasing member is ring-shaped and forms part of said first passage of said first sealing mechanism.

5. The ball valve as claimed in claim 4, further comprising:
a second cap mounted to said second side of said housing body and formed with a second cap opening in fluid communication with said ball socket, said valve ball permitting fluid flow between said second cap opening and said ball channel when at the open position and blocking fluid flow between said second cap opening and said ball channel when at the closed position, and
a second sealing mechanism mounted in said ball socket and formed with a second passage for permitting fluid communication between said second cap opening and said ball channel of said valve ball, said second sealing mechanism cooperating with said housing body and said valve ball to form a fluid-tight seal around said second passage between said valve ball and said second cap.

6. The ball valve as claimed in claim 5, wherein said second sealing mechanism includes
a second seat ring made of metal and abutting against said outer surface of said valve ball,
a second inner ring made of metal, abutting against said second seat ring opposite said valve ball, and abutting against said inner surface of said housing body,
a second outer ring made of metal, abutting against said second inner ring, and being sheathed over said second seat ring, and
a second biasing member made of metal and biasing said second outer ring away from said second cap,
wherein an opening formed in each of said second seat ring, said second inner ring, and said second outer ring cooperate to form said second passage of said second sealing mechanism.

7. The ball valve as claimed in claim 6, wherein
said second seat ring includes a second seat body abutting against said outer surface of said valve ball and having an outer ring wall, and a second radial flange extending away from said outer ring wall, and
said second inner ring is retained between said second radial flange and said second outer ring to be driven against said inner surface of said housing body.

8. The ball valve as claimed in claim 7, wherein:
said second inner ring tapers toward said second outer ring, and has a second inclined face that abuts against said second outer ring;
said second outer ring includes
a second ring body for sleeving over said outer ring wall of said second seat body,
a second spacer extending from said second ring body toward said second cap, and
a second wedge projecting from said second ring body and formed with a second wedge face for abutting against said second inclined face to drive said second inner ring towards said inner surface of said housing body; and
said second biasing member is positioned by said second spacer, and abuts against said second cap and said second outer ring opposite said second radial flange.

9. The ball valve as claimed in claim 8, wherein said second biasing member is ring-shaped and forms part of said second passage of said second sealing mechanism.

10. The ball valve as claimed in claim 9, wherein said first passage and said first cap opening cooperate to form a fluid outlet, and said second passage and said second cap opening cooperate to form a fluid inlet.
